(19) United States
(12) Patent Application Publication
(10) Pub. No.: US 2010/0199201 A1
(43) Pub. Date: Aug. 5, 2010

(54) SYSTEM AND METHOD FOR DISPLAYING A DISPLAY PANEL

(75) Inventors: Lei Song, Shenzhen (CN); Tianhua Duan, Shenzhen (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company Limited, Shenzhen (CN)

(21) Appl. No.: 12/759,790

(22) Filed: Apr. 14, 2010

Related U.S. Application Data
(63) Continuation of application No. PCT/CN2008/072954, filed on Nov. 5, 2008.

(30) Foreign Application Priority Data
Nov. 8, 2007 (CN) 200710177036.7

(51) Int. Cl. G06F 3/048

(52) U.S. Cl. 715/769; 715/781

(57) ABSTRACT

A method and system for displaying a display panel are provided. The system includes an image input module and an image display module. The image input module is adapted to obtain an image file selected by a user and parse the image file into image data; the image display module is adapted to display the image data obtained by the image input module on the display panel.

### FIELD OF THE INVENTION

The present invention relates to the field of instant messaging systems, and more particularly, to a system and method for displaying a display panel in an Instant Messaging tool.

### BACKGROUND OF THE INVENTION

With rapid development of Internet techniques, more and more people communicate with each other via instant messages on the network. Currently, Instant Messaging (IM) tools have been accepted by most network users. The IM tools are widely used not only in leisure and entertainment but also in working environments. At present, an IM tool has become an indispensable tool on user's desktop and takes an indispensable role in the user's work and life.

With the frequent use of the IM tools, the users have more and more requirements of the IM tools. For example, an individualized displaying technique is urgently required to display a display panel of an IM client to exhibit individuality of the user.

### SUMMARY OF THE INVENTION

Embodiments of the present invention provide a system and method for displaying a display panel of an instant messaging tool, which can provide a highly-customized and convenient display solution.

According to an embodiment of the present invention, a system for displaying a display panel is provided. The system includes:

an image input module, adapted to obtain an image file selected by a user, and parse the image file into image data; and

an image display module, adapted to display the image data obtained by the image input module on the display panel.

According to another embodiment of the present invention, a method for displaying a display panel is provided. The method includes:

obtaining an image file selected by a user;

parsing the image file into image data; and

displaying the image data on the display panel.

In the embodiments of the present invention, an image file is obtained and is directly parsed into image data. Then the image data are displayed on the display panel. Therefore, as to the user, any picture if only it is stored in a local computer may be displayed on the display panel according to the system and method provided by the embodiments of the present invention.

### BRIEF DESCRIPTION OF THE DRAWINGS

FIG. 1 is a schematic diagram illustrating a structure of a display system according to an embodiment of the present invention.

FIG. 2 is a schematic diagram illustrating a structure of a display system according to another embodiment of the present invention.

FIG. 3 is a flowchart illustrating a display method according to an embodiment of the present invention.

### DETAILED DESCRIPTION OF THE INVENTION

The present invention will be described in detail hereinafter with reference to embodiments and accompanying drawings to make the technical solution and merits therein clearer.

Currently, there is a conventional technical solution which realizes customization of a display panel through a customized skin technique. This solution is as follows: a software developer or a service provider pre-configures dedicated customized skin files (the so-called customized skin files are a kind of customized display patterns) and stores the customized skin files in a designated directory of a computer; if a user requires a customized skin, a customized skin file may be selected from the customized skin files by an IM tool; then, the IM tool applies the customized skin file to a display panel to replace an original background of the display panel.

The conventional individualized display solution is not customized enough, i.e. a user can select only from the customized skin files provided by the software developer or the service provider, but cannot configure the display manner of the display panel by himself.

In addition, the user has to perform complicated operations to use the existing individualized display solution, which is rather inconvenient.

Therefore, a highly-customized and convenient solution for displaying a display panel is urgently required.

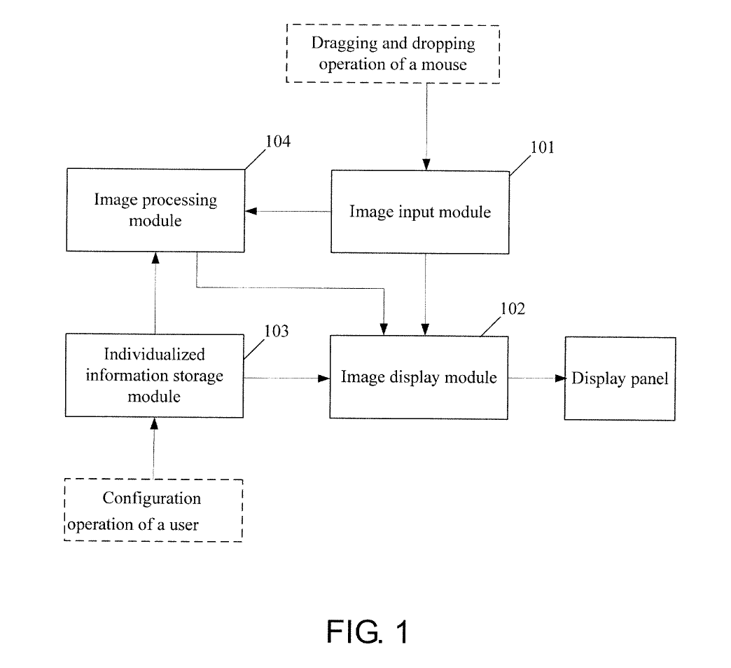

FIG. 1 is a schematic diagram illustrating a display system. As shown in FIG. 1, the display system mainly includes an image input module 101 and an image display module 102.

The image input module 101 is adapted to obtain an image file selected by a user, and parse the image file into image data. In an embodiment of the present invention, the image file obtained by the image input module 101 is an image file pointed by a source of an image-dragging operation of the user, wherein a destination of the image-dragging operation of the user should be the display panel. In another embodiment of the present invention, the image file obtained by the image input module 101 is an image file selected by the user from a file directory.

The image display module 102 is adapted to display the image data obtained by the image input module 101 on the display panel.

As can be seen from the above, through applying the individualized displaying solution provided by the embodiment of the present invention to the display panel, the user is enabled to randomly display any image on the display panel, so as to realize the individualized display. As such, it will take shorter time for the user to recognize a buddy's avatar. Therefore, the user is able to find the buddy quickly and perform relevant operations, which reduces man-machine interaction time and increases processing efficiency.

As described above, in the embodiment of the present invention, the image input module 101 may obtain the image file pointed by the source of the image-dragging operation through capturing the image-dragging operation of the user on the display panel. At this time, the image input module 101 may include a detecting unit, a file retrieving unit, an image file filtering unit and a parsing unit.

The detecting unit is adapted to detect an image-dragging operation of a mouse destined to the display panel.

The file retrieving unit is adapted to determine, after the detecting unit detects the image-dragging operation of the mouse, a storage directory of the file pointed by the source of the image-dragging operation, and retrieve the file according to the storage directory.

The image file filtering unit is adapted to determine the type of the file obtained by the file retrieving unit, transmit, if the file obtained by the file retrieving unit is an image file, the image file to the parsing unit for parsing, determine, if the file obtained by the file retrieving unit is not an image file, that the objective of the image-dragging operation is not individualized display, and ignore the image-dragging operation of the mouse without any processing.

The parsing unit is adapted to parse the image file from the image file filtering unit into image data.

As can be seen from the above, the user may select an image file through the image-dragging operation of the mouse to eventually display the selected image file on the display panel. As such, a dragging and dropping function of the image file is realized. The method is convenient and can increase the efficiency for realizing the individualized display.

In the embodiment shown in FIG. 1, the display panel may be an IM main panel, or an IM buddy panel or an IM close-buddy panel of an IM tool.

The IM buddy panel is located in the IM main panel and what are displayed are buddy contacts.

The close-buddy panel is independent from the IM main panel and exhibits information similarly to the main panel. For example, it is possible to display relevant information of a close-buddy, such as head portrait, status, customized signature, service information, etc., on the close-buddy panel; and initiate a session with the close-buddy. The close-buddy panel also supports features such as pinning, setting-top, making-transparent, appearance customizing, etc. The user may “copy” information of some frequently contacted buddies (also referred to as close-buddies) from the main panel to the close-buddy panel. Specifically, contacts in the close-buddy panel are also in the main panel, but a contact in the main panel is not always in the close-buddy panel. As such, the user may hide the main panel and the buddy panel on the main panel during a chat, and exchange instant messages with a close-buddy in the close-buddy panel through the close-buddy panel. Therefore, the user is extricated from searching for the close-buddy among a large group of buddies on the main panel when chatting with the close-buddy.

In another embodiment of the present invention, it is further possible to display the image file pointed by the source of the image-dragging operation of the user in a specific area of the display panel, so as to differentiate the specific area from other areas. Therefore, the time for the user to recognize the buddy's avatar is further reduced, the user may find the buddy quickly and the processing efficiency is increased. The user does not have to search a buddy list for the buddy repeatedly each time he wants to chat with the buddy. In particular, the specific area of the display panel may be a background skin of the display panel, or a contact's background area or head portrait in the IM close-buddy panel, the IM buddy panel or the IM main panel. Or, the specific area may also be background areas or head portraits of more than one contact in the IM close-buddy panel, IM buddy panel or the IM main panel. In this embodiment, the above specific area is referred to as a painted object or a painted area.

In order to achieve the above objective, the image display module 102 may include a painted-object configuring unit and a display unit. The painted-object configuring unit is adapted to determine the specific area of the display panel, and trigger, after receiving the image data obtained by the image input module 101, the display unit to display the image data on the specific area configured. The display unit is adapted to display the image data obtained by the image input module 101 on the specific area configured by the painted-object configuring unit. Specifically, the painted-object configuring unit may firstly provide the user with a selection interface including various specific areas, and then determine the specific area according to the user's selection. The painted-object configuring unit may also determine the destination of the image-dragging operation of the mouse of the user as the specific area according to the image-dragging operation. For example, if the specific area configured by the painted-object configuring unit is the background of the close-buddy panel, the display unit paints the image file pointed by the source of the image-dragging operation of the user on the background of the close-buddy panel. For another example, if the specific area configured by the painted-object configuring unit is a head portrait of a close-buddy in the close-buddy panel, the display unit paints the image file pointed by the source of the image-dragging operation on the head portrait of the close-buddy in the close-buddy panel, so as to achieve the purpose of replacing the original head portrait of the close-buddy.

As shown in FIG. 1, in another embodiment of the present invention, the display system may further include: a individualized information storage module 103 and an image processing module 104.

The individualized information storage module 103 is adapted to store individualized processing information of the image file. The individualized processing information may include characteristic processing information related to image characteristic processing, such as pining, setting-top, making-transparent, appearance customizing, etc. It may further include individualized customization information related to appearance customizing, such as mixed with a picture, transparency, matte effect, rotation, zooming-in/zooming-out, combination, etc.

The image processing module 104 is adapted to perform individualized processing to the image data obtained by the image input module through a corresponding image processing method according to the individualized processing information stored in the individualized information storage module 103 to generate new image data, and transmit the new image data to the image display module 102.

In the embodiments of the present invention, the image processing module 104 may process the image data through existing processing methods, e.g. perform the zooming-in/zooming-out operation through a bilinear interpolation algorithm. The existing methods will not be described herein.

The image display module 102 is adapted to directly paint the new image data on the display panel.

In the above embodiment, according to the individualized processing information stored, the display system may fix or do not fix the display panel to any position of a computer's desktop, or implement individualized display of the display panel such as setting top or making transparent.

In anther embodiment of the present invention, the individualized customization information (e.g. mixed with a picture, transparency, matte, rotation, zooming-in/zooming-out, combination, etc.) may also be stored in the image display module 102. Thus, after receiving the new image data from the image processing module 104, the image display module 102 may perform individualized processing to the new image data according to the individualized customization information stored and then paint the new image data after the individualized processing on the display panel.

The individualized processing solution provided by the embodiments of the present invention makes the display effect more individualized. The user may configure individualized display for a buddy image according to his/her requirement, which further reduces the time for recognizing the avatar of the buddy.

As described above, in the embodiments of the present invention, the display panel may be the main panel, or the close-buddy panel which is independent from the main panel. When changing the display of the close-buddy panel, the user may also expect that the main panel can be changed synchronously. Similarly, when changing the display of the main panel, the user may also expect that the display of the close-buddy panel can be changed synchronously. Therefore, another embodiment of the present invention provides a display system for solving this problem.

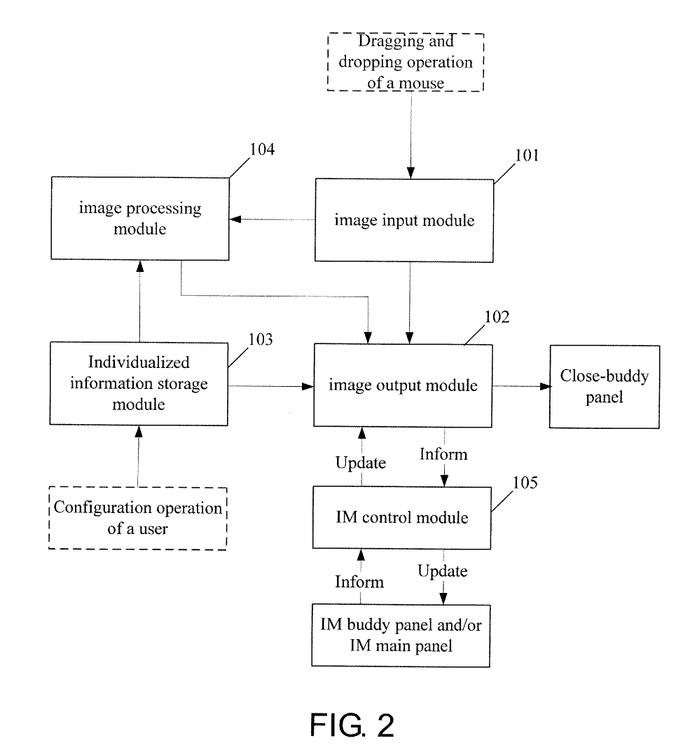

FIG. 2 is a schematic diagram illustrating a display system according to another embodiment of the present invention. As shown in FIG. 2, besides an image input module 101, an image display module 102, a individualized information storage module 103 and an image processing module 104, the display system in this embodiment further includes an IM control module 105. The IM control module 105 is adapted to obtain display update information of the display panel including image data and a specific area where the update locates, paint the image data contained in the display update information on an area of a second display panel corresponding to the specific area, so as to update the original image on the corresponding area of the second display panel. For example, if the display panel is the main panel or the buddy panel, the second display panel may be the close-buddy panel. Alternatively, if the display panel is the close-buddy panel, the second display panel may be the main panel or the buddy panel.

As can be seen from the above, after the display system realizes the individualized display of one display panel, the customized effect may be synchronously displayed on another display panel through the IM control module 105, so as to realize the same individualized displaying effect on two display panels.

Based on the above display system, embodiments of the present invention also provide a method for displaying a display panel. The method includes: obtaining an image file selected by a user; parsing the image file into image data; and displaying the image data on the display panel.

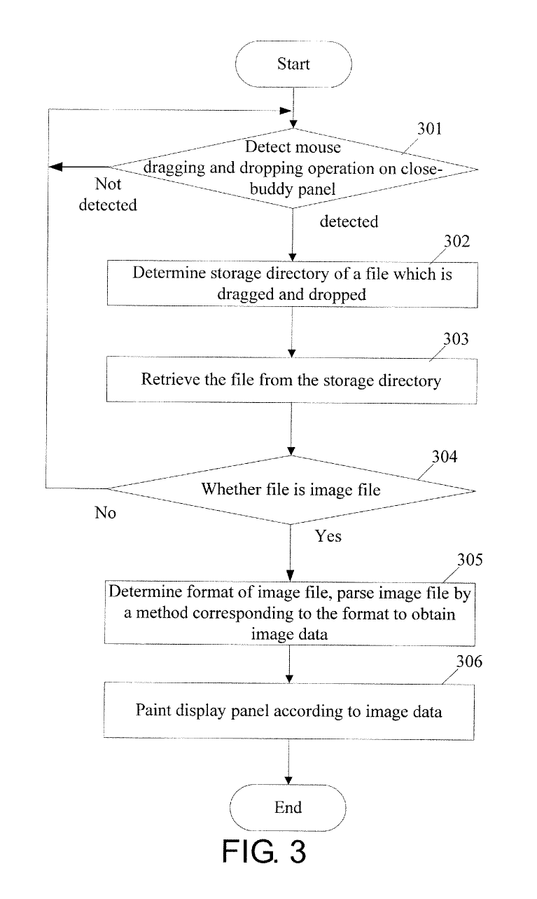

According to an embodiment of the present invention, the step of obtaining the image file selected by the user may include: capturing an image-dragging operation of the user on the display panel, obtaining the image file pointed by a source of the image-dragging operation. Thus, according to the method provided by the embodiment of the present invention, the image file pointed by the source of the image-dragging operation may be displayed on the display panel, so as to realize dragging and dropping function of the display panel. The detailed process is shown in FIG. 3, including the following steps:

Step 301, detect an image-dragging operation of a mouse on the display panel, if an image-dragging operation is detected, proceed to step 302; otherwise, return to step 301 to keep on detecting.

Step 302, determine a storage directory of a file pointed by the source of the image-dragging operation. Actually, what is pointed by the source of the image-dragging operation is generally a file icon, or a picture preview icon, etc.

Step 303, retrieve the file from the storage directory.

Step 304, determine whether the file is an image file, if the file is an image file, proceed to step 305; otherwise, return to step 301.

Step 305, determine a format of the image file, and parse the image file through a corresponding format parsing method to obtain image data. For example, if the format of the image file is JPG, a parsing method corresponding to the JPG format is used for parsing the image file to generate image data.

Step 306, paint the display panel using the image data, i.e. display the image data on the display panel.

In another embodiment of the present invention, the method may further include: pre-determining a specific area on the display panel. Thus, during the display of the image data, it is possible to paint the image data on the specific area of the display panel. For example, a configuration interface may be provided for the user to configure the painted object, e.g. the painted object may be the background of the close-buddy panel. Then the image data is painted on the background of the close-buddy panel to replace the original background, so as to realize the dragging and dropping function on the background of the close-buddy panel. Similarly, the painted object may also be the background or head portrait of a user in the close-buddy panel, or the backgrounds or head portraits of more than one user in the close-buddy panel. As such, the dragging and dropping function is realized for the background or head portrait of one or more contacts in the close-buddy panel.

In anther embodiment of the present invention, in step 301, an area of the display panel where the destination of the image-dragging operation belongs may be further determined. This area is taken as the specific area, i.e. painted object. The painted object is stored temporarily for the processing in step 306. The painted object may be a background area on the close-buddy panel, a background or a head portrait of a contact in the close-buddy panel, backgrounds or head portraits of more than one contact in the close-buddy panel, or other areas, etc. In step 306, the painted object determined in step 301 may be obtained, and the image data is painted on the painted object to realize the dragging and dropping function of the painted object.

In addition, in another embodiment of the present invention, the method may further include: configuring individualized processing information of the image, e.g. characteristic processing information and individualized customization information. The display system may provide a configuration interface for the user to configure the individualized processing information. Thus, in step 306, the display system may further perform individualized processing to the image data obtained in step 305 according to the individualized processing information configured and then paint the image data after the individualized processing on the display panel.

For example, suppose the individualized processing information is: mixing multiple pictures into a new picture according to a pre-defined proportion. The user drags (simultaneously or sequentially) multiple pictures onto the display panel (e.g. the close-buddy shortcut panel, the buddy panel or the main panel). Next, through performing the above steps 301 to 305 for each picture, image data of each picture is obtained respectively. Then, multiple pictures are mixed into a new one by an image mixing technique according to the individualized processing information. After obtaining the processed image data, the image display module 102 displays the image data on the display panel.

The image mixing technique may be divided into two types, overlap mixing and combination mixing, and can realize mixing of multiple pictures. Hereinafter the two types of image mixing techniques will be described in detail.

The detailed process of the overlap mixing technique includes:

a1) pre-configure a mixing proportion of each picture, e.g. a first picture occupies 70% and a second picture occupies 30%. If the pictures are dragged sequentially, the order of the pictures for mixing may be determined according to the sequence in which they are dragged, i.e. the picture dragged firstly is the first picture and the picture dragged later is the second picture. If the pictures are dragged simultaneously, the order of the pictures for mixing may be determined according to their relative positions, e.g. the upper one is the first picture and the lower one is the second picture.

b1) perform the above steps 301 to 305 to each picture to obtain image data of each picture, analyze RGB data of each pixel of each picture.

c1) with respect to a pixel on the same position of the pictures, perform a weighted calculation to the RGB data corresponding to the pixel in the pictures according to a pre-defined proportion to obtain new RGB data of the pixel. For example, suppose the first picture has a proportion of 70%, the data of pixel A on the first picture is A1, the second picture has a mixing proportion of 30% and the data of pixel A on the second picture is A2. Then the data of pixel A on the new picture is A1*70%+A2*30%

If the two pictures are dragged simultaneously, position parameters of the two pictures on the screen may be obtained according to click operations of the mouse during the image-dragging operations. According to the pre-defined relative position order (e.g. upper-lower order), which is the first picture and which is the second picture are determined.

d1) compose each pixel with the new RGB data into a new picture.

The detailed process of the combination mixing technique includes:

a2) pre-configure a size and a position occupied by each picture in the new picture. For example, the first picture occupies 70% of the height of the new picture and is located in the upper part. The second picture occupies 30% of the height of the new picture and is located in the lower part. If the pictures are dragged sequentially, the order of the pictures for combination may be determined according to the sequence in which they are dragged, i.e. the one dragged firstly is the first picture and the one dragged later is the second picture. If the pictures are dragged simultaneously, the order of the pictures for combination may be determined according to their relative positions, e.g. the upper one is the first picture and the lower one is the second picture.

b2) perform the above steps 301 to 305 to each picture to obtain image data, and convert the pictures into the pre-configured sizes.

c2) combine the converted pictures according to the pre-defined positions to obtain the new picture.

In addition, when the pictures are dragged sequentially, the latter one may overlap the former one or be mixed with the former one, which is configurable. If it is configured that the latter one overlaps the former one, after obtaining the image data of the latter picture through the steps 301 to 305, the latter picture will be directly overlapped on the display panel to replace the former picture. If it is configured that the latter picture is mixed with the former picture, after obtaining the image data of the latter picture through the steps 301 to 305, the latter picture will be taken as the second picture to be mixed with the former picture which is taken as the first picture. If there are multiple former pictures, a mixed picture of the multiple former pictures will be taken as the first picture, the latter picture is taken as the second picture, and the first picture and the latter picture mixed into a new picture.

The above mixing processing techniques are only preferred embodiments of the present invention. It is also possible to pre-configure other mixing processing information for the user to select, and perform the mixing processing according to the user' selection.

The display panel may be the IM close-buddy panel, IM buddy panel and the IM main panel.

In another embodiment of the present invention, after step 306, the method may further include: obtaining display update information of the display panel, wherein the display update information may include detailed image data and a specific area of the update; paint the image data contained in the display update information on an area of a second display panel corresponding to the specific area to update the original image in the corresponding area of the second display panel. If the display panel is the main panel or the buddy panel, the second display panel may be the close-buddy panel. Alternatively, if the display panel is the close-buddy panel, the second display panel may be the main panel or the buddy panel.

The foregoing descriptions are only preferred embodiments of this invention and are not for use in limiting the protection scope thereof. Any changes and modifications can be made by those skilled in the art without departing from the spirit of this invention and therefore should be covered within the protection scope as set by the appended claims.

1. A system for displaying a display panel, comprising:
an image input module, adapted to obtain an image file selected by a user, and parse the image file into image data; and
an image display module, adapted to display the image data obtained by the image input module on the display panel.

2. The system of claim 1, wherein the image input module comprises:
a detecting unit, adapted to detect an image-dragging operation destined to the display panel;
a file retrieving unit, adapted to determine a storage directory of a file pointed by a source of the image-dragging operation after the detecting unit detects the image-dragging operation, and retrieve the file according to the storage directory;
an image file filtering unit, adapted to determine a type of the file retrieved by the file retrieving unit, and output, if the file retrieved by the file retrieving unit is the image file, the image file; and
a parsing unit, adapted to parse the image file from the image file filtering unit into the image data.

3. The system of claim 1, wherein the image display module comprises:
a painted-object configuring unit, adapted to determine a specific area on the display panel; and
a display unit, adapted to display the image data obtained by the image input module on the specific area configured by the painted-object configuring unit.

4. The system of claim 1, further comprising:
an individualized information storage module, adapted to store individualized processing information of the image file; and
an image processing module, adapted to perform individualized processing to the image data obtained by the image input module according to the individualized processing information stored in the individualized information storage module to generate new image data, and transmit the new image data to the image display module for display.

5. The system of claim 1, further comprising:
an Instant Messaging (IM) control module, adapted to obtain the image data displayed on the display panel and a specific area where the image data is displayed, paint the image data on an area of a second display panel corresponding to the specific area.

6. The system of claim 1, wherein the display panel is a close-buddy panel, or a main panel or a buddy panel of an Instant Messaging (IM) tool.

7. A method for displaying a display panel, comprising:
obtaining an image file selected by a user;
parsing the image file into image data; and
displaying the image data on the display panel.

8. The method of claim 7, wherein the obtaining the image file selected by the user and parsing the image file into image data comprises:
detecting an image-dragging operation destined to the display panel;
after detecting the image-dragging operation destined to the display panel, determining a storage directory of a file pointed by a source of the image-dragging operation;
retrieving the file according to the storage directory; and
determining a type of the file, if the file is the image file, parsing the image file into the image data.

9. The method of claim 7, wherein the displaying the image data on the display panel comprises:
displaying the image data in a pre-determined specific area of the display panel.

10. The method of claim 9, further comprising:
determining an area where a destination of the image-dragging operation belongs; and
determining the area where the destination of the image-dragging operation belongs as the specific area.

11. The method of claim 10, wherein the specific area is a background of the display panel, or a background area or head portrait of a contact in the display panel, or backgrounds or head portraits of more than one contact in the display panel.

12. The method of claim 9, wherein the specific area is a background of the display panel, or a background area or head portrait of a contact in the display panel, or backgrounds or head portraits of more than one contact in the display panel.

13. The method of claim 7, wherein the displaying the image data on the display panel comprises:
configuring individualized processing information for the image data;
performing individualized processing to the image data according to the individualized processing information configured; and
displaying the processed image data on the display panel.

14. The method of claim 13, wherein multiple image files are obtained, and the performing the individualized processing to the image data comprises:
mixing image data obtained by parsing the image files, and displaying the mixed image data on the display panel.

15. The method of claim 9, further comprising:
obtaining the image data displayed on the display panel and a specific area where the image data is displayed; and
painting the image data on an area corresponding to the specific area on a second display panel to update an image in the corresponding area of the second display panel.

16. The method of claim 7, wherein the display panel is a close-buddy panel, or a buddy panel or a main panel of an Instant Messaging (IM) tool.

17. The method of claim 8, wherein the display panel is a close-buddy panel, or a buddy panel or a main panel of an Instant Messaging (IM) tool.

18. The method of claim 9, wherein the display panel is a close-buddy panel, or a buddy panel or a main panel of an Instant Messaging (IM) tool.

19. The method of claim 10, wherein the display panel is a close-buddy panel, or a buddy panel or a main panel of an Instant Messaging (IM) tool.

20. The method of claim 12, wherein the display panel is a close-buddy panel, or a buddy panel or a main panel of an Instant Messaging (IM) tool.
